(19) United States
(12) Patent Application Publication
(10) Pub. No.: US 2023/0157195 A1
(43) Pub. Date: May 25, 2023

(54) IMPLEMENTS FOR DISPLACING GROUND MATERIAL

(71) Applicant: Claussen Technology, LLC, Benson, MN (US)

(72) Inventor: Steven W. Claussen, Glenwood, MN (US)

(21) Appl. No.: 17/992,883

(22) Filed: Nov. 22, 2022

Related U.S. Application Data
(60) Provisional application No. 63/282,173, filed on Nov. 22, 2021.

(51) Int. Cl. A01B 15/16; A01B 5/10

(52) U.S. Cl. CPC A01B 15/16; A01B 5/10

(57) ABSTRACT

Implement apparatus may be configured to displace ground material. For example, an implement may include an extension member coupled to a roller apparatus. The roller apparatus may include a cylindrical portion and a plurality of ground displacing elements. The ground displacing elements may be configured to extend into a ground surface to disperse ground material when the roller apparatus is engaged with the ground surface as the vehicle traverses the ground surface.

This application claims the benefit of U.S. Provisional Patent Application No. 63/282,173 filed on Nov. 22, 2021, which is incorporated by reference herein in its entirety.

The present disclosure relates to implements and implement systems for use in displacing ground material. The implements may include roller apparatus configured to engage a ground surface and form a plurality of reservoirs in the ground surface.

Water distributed through irrigation systems or from rain may be unevenly dispersed over an agricultural field due to runoff and further may be subject to evaporation. For example, a sloped or angled ground surface may also contribute to water runoff where water may run from higher areas of a field to lower areas of the field. Additionally, water exposed on the top of the ground surface may be subject to evaporation.

### SUMMARY

The present disclosure describes exemplary implements, implement systems, and methods for use in conditioning soil. The exemplary implements and implement systems may be configured to be attached to a vehicle such as, e.g., a tractor. The vehicle may traverse a ground surface, such as a field, towing one or more implements in between planted rows of vegetation or crops such as, e.g., corn, soybeans, cotton, wheat, potatoes, sugar beets, sunflowers, and all row crops, etc., or in the preparation of land for construction. An exemplary implement may generally include roller apparatus and an extension member configured to hold, or position, the roller apparatus such that it may engage the ground surface to form a plurality of reservoirs in the ground surface. For example, the extension member may be configured to apply down pressure to the roller apparatus such that the roller apparatus continuously engages the ground surface when in use. The extension member may be pivotably attached to a mount portion, which may be configured to be attached to the vehicle.

One or more implements may be part of an exemplary system. For example, a plurality of implements, as described herein, may be part of an exemplary implement system. An exemplary system may generally include a frame apparatus (such as, e.g., a beam or other structure) for supporting the plurality of implements and coupling them to the vehicle. Each mount portion of the plurality of implements may be configured to mount or couple each implement to the frame apparatus. In the exemplary system, the plurality of implements may be coupled to the frame apparatus in a spaced apart arrangement along the frame apparatus to facilitate each of the plurality of implements passing between rows of crops.

One exemplary implement couplable to a vehicle configured to traverse a ground surface may include a mount portion couplable to a vehicle, an extension member extending from a proximal end portion to a distal end portion (e.g., wherein the proximal end portion is pivotably coupled to the mount portion about a pivot axis), and a roller apparatus rotatably coupled to the distal end portion of the extension member about a roller axis. For example, the roller apparatus may include a cylindrical portion lying along the roller axis configured to roll over a ground surface (e.g., wherein the cylindrical portion may define an outer surface configured to engage the ground surface when the cylindrical portion is rolled over the ground surface) and a plurality of ground displacing elements coupled to the cylindrical portion and extending from the outer surface of the cylindrical portion (e.g., wherein each ground displacing element of the plurality of ground displacing elements may include a ground lifting surface configured to engage and lift ground material to disperse the ground material and form a plurality of reservoirs in the ground surface when the outer surface is engaged with the ground surface as the cylindrical portion is rolled over the ground surface). The mount portion may be configured to transmit force to the roller apparatus to maintain engagement between the outer surface of the cylindrical portion and the ground surface when the cylindrical portion is rolled over the ground surface.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1A is a perspective view of an exemplary implement.

FIG. 1B is a top view of the implement of FIG. 1A.

FIG. 1C is a top view of the implement of FIG. 1A.

FIG. 1D is a perspective view of the roller apparatus of the implement of FIG. 1A.

FIG. 1E is an enlarged top view of the roller apparatus of the implement of FIG. 1A.

FIG. 1F is an enlarged side view of an exemplary ground displacing element of the roller apparatus of the implement of FIG. 1A.

FIG. 1G is an enlarged top view of the ground displacing element of FIG. 1F.

FIG. 2A is a side plan view of an exemplary implement including a cleaner apparatus and a hipper apparatus.

FIG. 2B is a front perspective view of the implement of FIG. 2A.

FIG. 2C is a rear perspective view of the implement of FIG. 2A.

FIG. 3A is another perspective view of an exemplary implement.

FIG. 3B is a cross-sectional side plan view of the implement of FIG. 3A illustrating the plurality of ground displacing elements.

FIG. 3C is a front plan view of the implement of FIG. 3A.

FIG. 4A is a front perspective view of another exemplary implement including a cleaner apparatus and a hipper apparatus.

FIG. 4B is a rear perspective view of the implement of FIG. 4A.

FIG. 4C is a side plan view of the implement of FIG. 4A.

### DETAILED DESCRIPTION OF EXEMPLARY EMBODIMENTS

In the following detailed description of illustrative embodiments, reference is made to the accompanying figures of the drawings which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

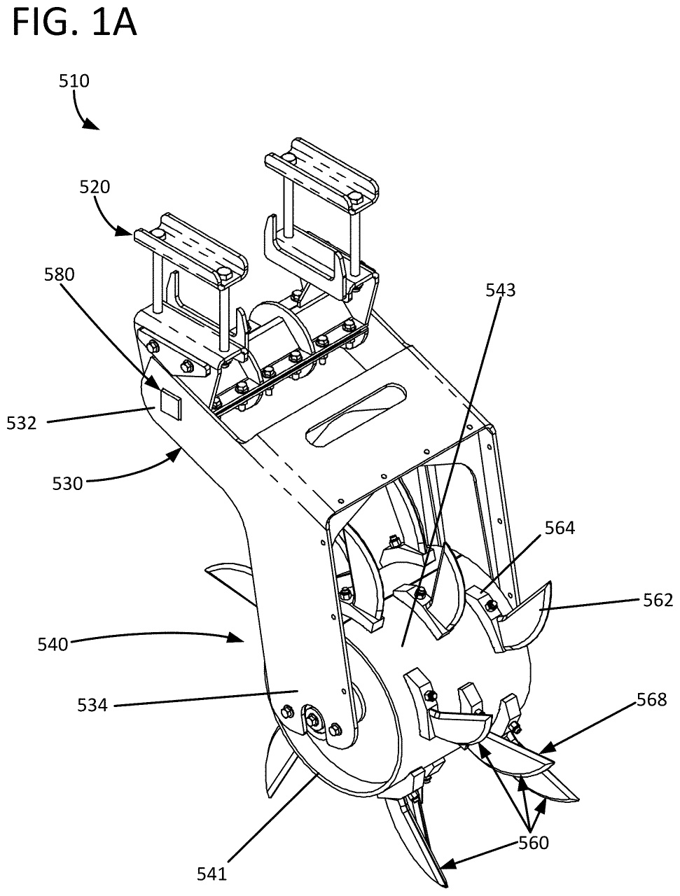

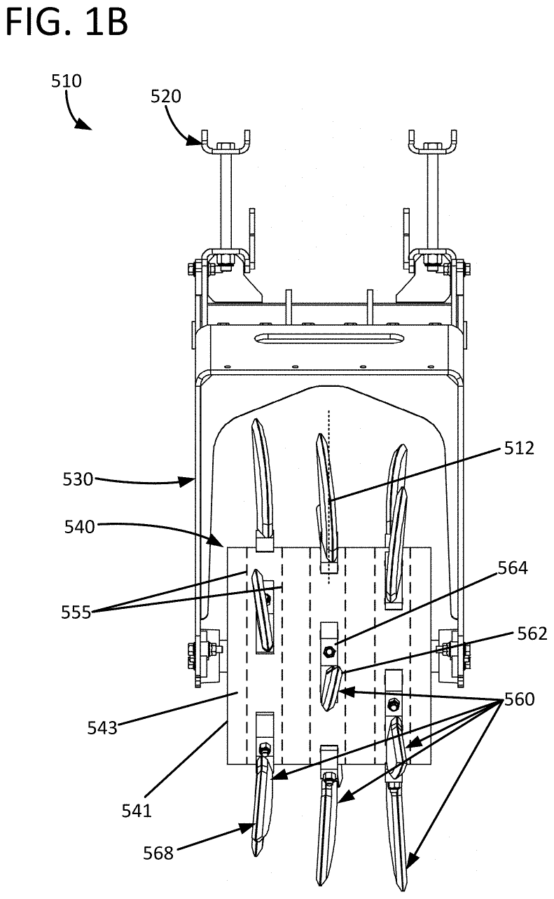

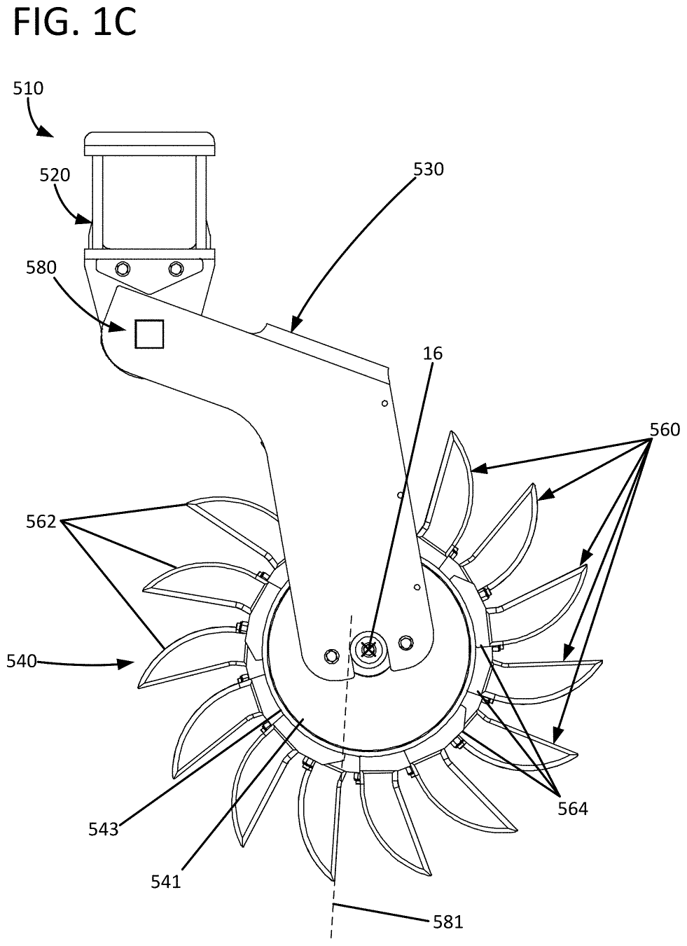

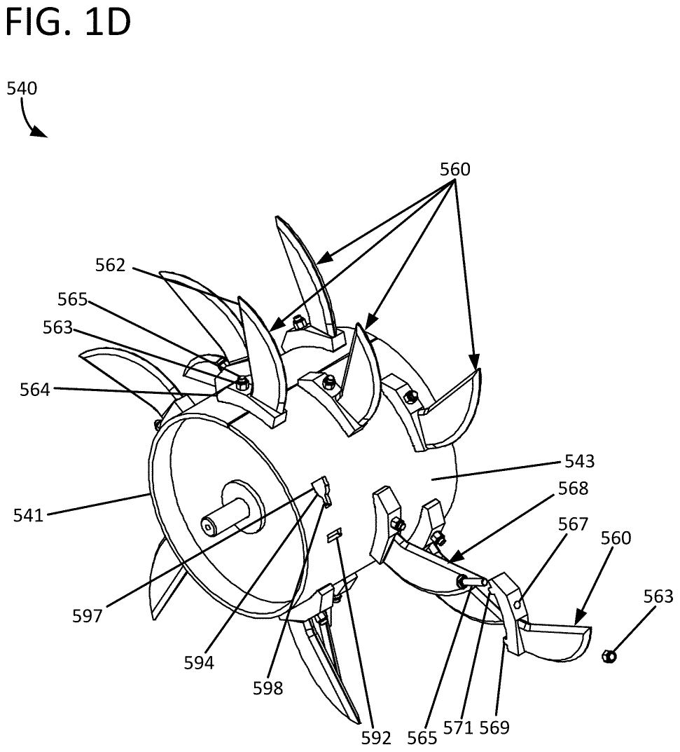

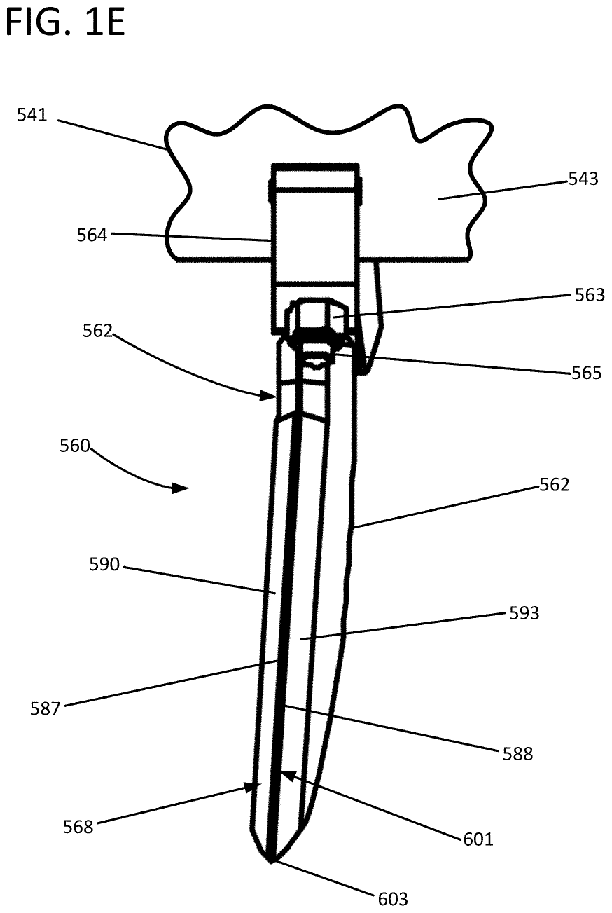

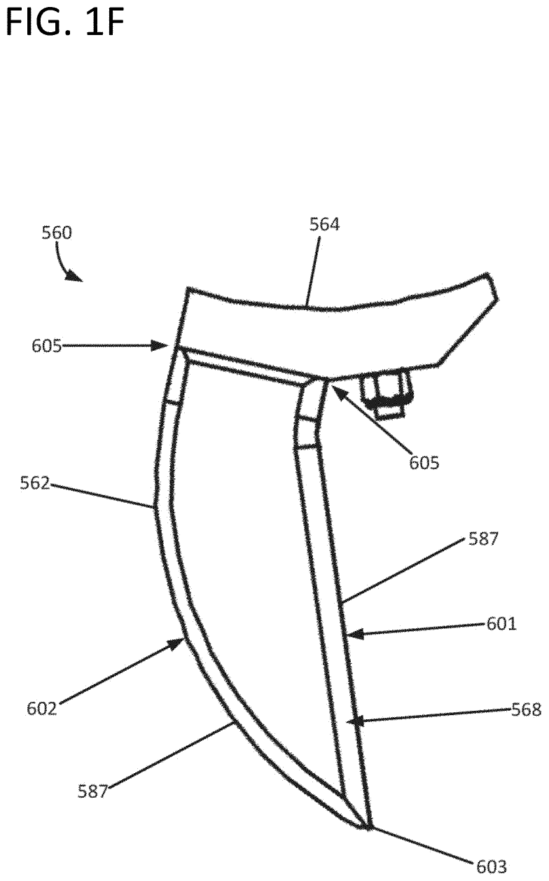

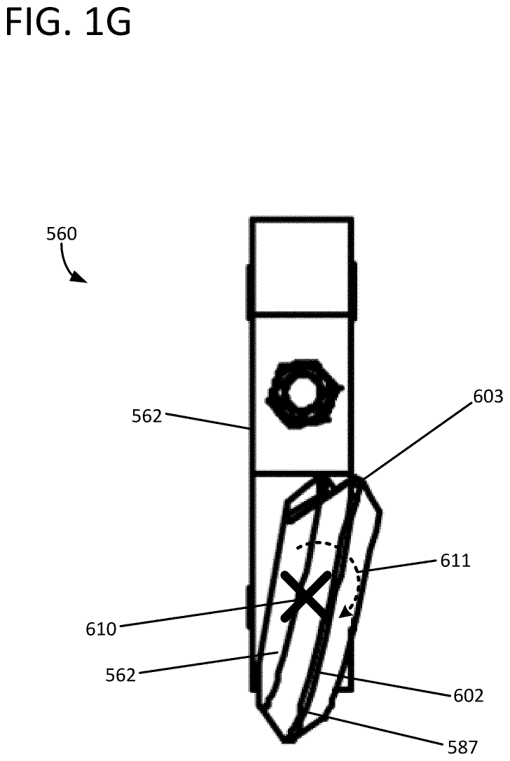

Exemplary apparatus, systems, and methods shall be described with reference to FIGS. 1-3. It will be apparent to one skilled in the art that elements from one embodiment may be used in combination with elements of the other embodiments, and that the possible embodiments of such apparatus, systems, and methods using combinations of features set forth herein is not limited to the specific embodiments shown in the figures and/or described herein. Further, it will be recognized that the embodiments described herein may include many elements that are not necessarily shown to scale. Still further, it will be recognized that the size and shape of various elements herein may be modified but still fall within the scope of the present disclosure, although certain one or more shapes and/or sizes, or types of elements, may be advantageous over others.

Exemplary implements, implement systems, and methods described herein may be configured to engage a ground surface and till, aerate, and/or form a plurality reservoirs in the ground surface. The exemplary implements may include roller apparatus, and the roller apparatus may include a plurality of ground displacing elements shaped, sized, and/or configured in many different ways which will be described herein with respect to FIGS. 1-3. As used herein, a “reservoir” may be defined as an indentation, recess, and/or cavity formed within a ground surface configured such that fluid (e.g., water) or material may be collected and/or held therein.

An exemplary implement 510 depicted in FIGS. 1A-1G may include a mount portion 520, an extension member 530, and a roller apparatus 540. The mount portion 520 may be configured to be coupled to a vehicle (not shown), such as a tractor, to couple the exemplary implement 510 to the vehicle. The vehicle may be used to pull the implement between rows of vegetation or crops to form a plurality of reservoirs or to loosen the ground (e.g., aerate, till, etc.) between the rows using the implement 510. To provide the coupling between the implement 510 and a vehicle, the mount portion 520 may include one or more mounting brackets configured to be coupled, or attached, to a portion of a vehicle. As shown, the mounting brackets may define a plurality of apertures, or openings, through which fasteners, such as bolts, may extend to couple the brackets to the vehicle. Further, other features of the implement 510 may be included as described in U.S. Pat. No. 9,674,996 entitled “Implement for Displacing Ground Material,” which is herein incorporated by reference. As such, it is to be understood that one or more such features and/or portions therein may be used interchangeably between each and every embodiment described herein.

The mount portion 520 may not be directly coupled to a vehicle, and instead, may be coupled to apparatus that is coupled to the vehicle. For example, the mount portion 520 may be coupled to frame apparatus, such as, e.g., a beam, or other support member, which may be coupled to the vehicle. In one or more embodiments, exemplary frame apparatus may be raised or lowered by the vehicle so as to raise or lower the implement 510 to engage a ground surface. For example, the mount portion 520 may be couplable to and/or coupled to a frame apparatus that extends transverse to the forward moving direction of a vehicle and the frame apparatus may be coupled to a hydraulic system of the vehicle to raise and lower the implement 510 when used in conjunction with the vehicle.

The mount portion 520 may be configured to transmit force to the roller apparatus 540 from the vehicle to maintain engagement between the roller apparatus 540 and a ground surface when the roller apparatus 540 is rolled over the ground surface. For example, the vehicle may provide a force, or may allow the mass of the implement 510 itself to provide a force, to direct the roller apparatus 540 in engagement with the ground surface when in use, and the mount portion 520 may facilitate, or transmit, that force to the roller apparatus 540. Additionally, the mount portion 520 may be configured to transmit force to the roller apparatus 540 by being biased in a clockwise direction about a pivot axis. Other methods of transmitting force to the roller apparatus 540 may be used such as, e.g., airbags, a bellows suspension system, the weight of substance (e.g., fertilizer) tanks positioned thereon, a torsional spring system, a linear spring actuator system, a rotary or linear hydraulic actuator/accumulator system, etc.

The extension member 530 may extend from a proximal end portion 532 to a distal end portion 534 and may be pivotally coupled to the mount portion about the pivot axis. As used herein, “pivotally coupled” may be defined as a coupling between objects such that the objects are configured for pivotal movement in relation to each other. As depicted, the mount portion 520 may be pivotally coupled to the proximal end portion 532 of the extension member 530 through the use of an elongate torsion assembly 580 (see, e.g., a “Henschen” suspension as described in U.S. Pat. No. 3,436,069 entitled “Bearing Assembly for Elastic Joints” and issued to Henschen on Apr. 1, 1969 and U.S. Pat. App. Pub. No. 2007/0024016 A1 entitled “Parallel Torsion Suspension Assembly” published on Feb. 1, 2007, each of which are hereby incorporated by reference in their entireties).

In other embodiments, the mount portion may be pivotally coupled to the proximal end portion of the extension member through the use of, for example, a spring, a strut, a shock absorber, a linear spring/damper system, a rotary or linear hydraulic actuator/accumulator system or any suitable suspension element or system or combination of such elements or systems, etc.

The extension member 530 may be made, or formed of, metal such as steel, aluminum, cast iron, plastic (e.g., for example, fiber-reinforced or glass-filled) or any other suitable material. Further, the extension member 530 may be formed by cutting (e.g., laser cutting, stamping, blanking, water-jet cutting, or plasma cutting, etc.) a sheet of material and then bending, or forming, the sheet of material into the desired shape. Additionally, the extension member 530 may be formed using any suitable method including casting, forging or injection molding. As shown, one or more cutouts may be defined, or formed, in the extension member 530 to, e.g., reduce weight, provide access points for serviceability, provide debris cleanout and/or flow-through for debris, etc.

The distal end portion 534 of the extension member may extend towards the ground surface and may be coupled to the roller apparatus 540 to locate the roller apparatus 540 proximate the ground surface such that the roller apparatus 540 may engage and contact the ground (e.g., for example, continuously, to ensure that the roller apparatus 540 outer surface 543 of the cylindrical portion 541 maintains contact with the ground surface and does not bounce off the ground surface, or intermittently, so that the roller apparatus 540 or the outer surface 543 of the cylindrical portion 541 maintains contact with the ground surface at least a portion of the time) when in use.

The roller apparatus 540 may be configured to engage and lift ground material to disperse the ground material and/or form a plurality of reservoirs in the ground surface as the implement 510 traverses the ground surface. As the roller apparatus 540 traverses the ground surface, the roller apparatus 540 may roll over the ground surface. To facilitate the rotational motion of the roller apparatus 540, the roller apparatus 540 may be rotatably coupled to the distal end portion 534 of the extension member 530 about a roller axis 16. As used herein, “rotatably coupled” may be defined as a coupling between objects such that the objects are rotatable in relation to each other.

The roller apparatus 540 may include a cylindrical portion 541 defining an outer surface 543 and a plurality of ground displacing elements 560 (e.g., soil displacing elements). The cylindrical portion 541 may extend from a first end portion to a second end portion defining a roller width. The roller width (e.g., for example, a roller width sized to be positioned between crop rows) may be about 8 inches to about 42 inches, such as, e.g., about 8 inches, about 12 inches, about 21 inches, about 22 inches, about 24 inches, about 42 inches, or any size in between those described herein, but not limited thereto, etc., and may be dependent on the distance between crop rows for which the implement is intended to be used. Each of the first end portion and the second end portion may be rotatably coupled to the extension member 530 about the roller axis 16 such that the roller apparatus 540 is rotatably coupled to the extension member 530.

The plurality of ground displacing elements 560 may be coupled to the cylindrical portion 541 and extend outwardly from the outer surface 543 of the cylindrical portion 541. The plurality of ground displacing elements 560 may be configured to extend into the ground, or beyond the ground surface, to engage and lift ground material when the outer surface 543 of the cylindrical portion 541 is engaged with the ground surface as the roller apparatus 540 and portions thereof such as the cylindrical portion 541 are rolled over the ground surface. After the ground material is lifted by the ground displacing elements 560, the ground displacing elements 560 may disperse the ground material. In one or more embodiments, the ground material may be dispersed to the sides of the roller apparatus 540, e.g., direction traverse to the forward moving motion of the vehicle. Further, the ground displacing elements 560 may be described as being configured to dig, remove, separate, break apart, rip, and/or lift the ground material out of the ground, and subsequently, disperse the ground material.

As noted, the outer surface 543 of the cylindrical portion 541 may be configured to engage the ground surface when the cylindrical portion 541 is rolled over the ground surface. As used herein, “engage a ground surface” may be defined as touching, or contacting, the ground surface while the object is in use. For example, when the outer surface 543 of the cylindrical portion 541 of the roller apparatus 540 engages the ground surface, at least a portion of the outer surface 543 may touch, or be in contact, with the ground surface at least a portion of the time when in use. Further, in one embodiment, the exemplary implement 510 may be configured such that the outer surface 543 of the cylindrical portion 541 engages, or contacts, the ground continuously or intermittently when in use (e.g., the suspension apparatus coupling the mount portion 520 to the extension member 530 may transmit force to the roller apparatus 540 to provide continuous or intermittent engagement between the outer surface 543 of the cylindrical portion 541 and the ground surface).

As shown in FIG. 1A, the roller apparatus 540 may include cylindrical portion 541, which defines an outer cylindrical surface 543. The plurality of ground displacing elements 560 may be removably coupled to the cylindrical portion 541 (e.g., adjacent to the outer cylindrical surface 543, in contact with the outer cylindrical surface 543, etc.). As shown in FIG. 1B, the plurality of ground displacing elements 560 may be arranged in a plurality of rows (each row being noted as being between a pair of the dotted lines 555) that circumferentially extend around the outer cylindrical surface 543. In this embodiment, the plurality of ground displacing elements 560 may be arranged, or grouped, in three rows. In other embodiments, the plurality of ground displacing elements 560 may be arranged, or grouped, in more than three rows such as, e.g., four rows, six rows, etc. or less than three rows such as, e.g., two rows and one row. Additionally, in this embodiment, the plurality of ground displacing elements 560 may be described as being in a staggered configuration or arrangement. For example, the plurality of ground displacing elements 560 of the left-most row in FIG. 1B may not be coupled to the cylindrical portion 541 at the same point about the circumference of the cylindrical portion 541 as the plurality of ground displacing elements 560 of the other rows such as the middle row or right-most row. In other words, it may be described that the plurality of ground displacing elements 560 are staggered with respect to each other such that each of the plurality of ground displacing elements 560 do not extend from the same location, or point, about the circumference of the cylindrical portion as any other of ground displacing elements 560 (e.g., located in other rows). Further, although is this embodiment, all of the plurality of ground displacing elements 560 are staggered with respect to each other, it is to be understood that, in some embodiments, two or more rows of ground displacing elements 560 may be aligned with each other (e.g. located at the same point, or location, about the circumference of the cylindrical portion 541).

Each of the ground displacing elements 560 may include a blade portion 562 and an attachment portion 564 coupled (e.g., fixedly coupled, integral to, etc.) to the blade portion 562. The attachment portion 564 may be removably coupled to the cylindrical portion 541. More specifically, the attachment portion 564 may be removably coupled to the cylindrical portion 541 such that the attachment portion 564 is adjacent, or in contact with, at least a region or section of the outer cylindrical surface 543 of the cylindrical portion 541.

To provide the removable coupling between the attachment portion 564 and the cylindrical portion 541, the attachment portion 564 may define an opening 567 configured to receive a fastener 565 as shown in FIG. 1D which shows one ground displacing element 560 un-coupled from the cylindrical portion 541. The fastener 565 may be configured to be used, or in conjunction, with a keyhole-shaped opening 594 that extends through the outer cylindrical surface 543 of the cylindrical portion 541. Further, the cylindrical portion 541 may further define a secondary opening 592 for each of the ground displacing elements 560. Thus, the cylindrical portion 541 may define a plurality of secondary openings 592 (e.g., any shaped openings, or combination of openings, including holes, slots, or any other suitable openings) and a plurality of keyhole-shaped openings 594 (e.g., shaped openings providing the functionality described herein including a larger opening region adjacent a smaller opening region; such opening regions having any suitable shape). One secondary opening 592 and one keyhole-shaped opening 594 paired together may provide the coupling of a ground displacing element 560 to the cylindrical portion 541.

More specifically, each fastener 565 may be configured to extend through the opening 567 of the attachment portion 564 of the ground displacing element 560. During attachment, the fastener 565 may be first located in a larger region 597 of the keyhole-shaped opening 594 such that a portion of the fastener 565 (e.g., the head of a bolt) may be placed through the larger region 597 and then the ground displacing element 560 may be moved such that the fastener 565 may be located in a slot region 598 of the keyhole-shaped opening 594. When the fastener 565 is located in the slot region 598, a retention portion 569 of the attachment portion 564 of the ground displacing element 560 may align, or “line up,” with and be received by the secondary opening 592 to, e.g., assist in retaining the ground displacing element 560 coupled to the cylindrical portion 541. Additionally, the attachment portion 564 may further include an additional retention portion 571 configured to be located in the keyhole-shaped opening 594 (e.g., the larger region 597 of the keyhole-shaped opening 594). In other words, the attachment portion 564 of the ground displacing element 560 may include a first retention portion 569 configured to be located in the secondary opening 592 and a second retention portion 571 configured to be located in the larger region 597 of the keyhole-shaped opening 594 to restrict, or retain, the ground displacing element 560 to the cylindrical portion 541. Once the first and second retention portions 569, 571 are located in the secondary opening 592 and the larger region 597 of the keyhole-shaped openings 594 and the fastener 565 extends through the opening 567 and a portion of the fastener 565 is located in the slot region 598 of the keyhole-shaped opening 594, a nut 563, or other restriction device, may be coupled to the fastener 565 to couple the attachment portion 564 to the outer cylindrical surface 543 of the cylindrical portion 541.

In other words, the fastener 565 may be located in the opening 567 of the attachment portion 564 of the ground displacing element 560 and the ground displacing element 560 may be located, or positioned, such that a portion of the fastener 565 such as a “head” of a bolt extends through the larger region 597 of the keyhole-shaped opening 594 (e.g., extends through the outer cylindrical surface 543 of the cylindrical portion 541). Then, the ground displacing element 560 may be moved to slide the fastener 565 towards the slot region 598 of the keyhole-shaped opening 594 such that the portion of the fastener 565 is restricted from passing back through the keyhole-shaped opening 594 (e.g., due to the size of the slot region 598 being smaller than the larger region 597). Or, the fastener 565 may be located in the larger region 597 and slid into the slot region 594 prior to the ground displacing element 560 being positioned such that the fastener is located in the opening 567 and proximate the cylindrical portion 541. Additionally, the ground displacing element 560 may be moved to align the first and second retention portions 569, 571 with the secondary opening 592 and the larger region 597 of the keyhole-shape opening 594 such that the first and second retention portions 569, 571 may be received by the secondary opening 592 and the larger region 597 of the keyhole-shape opening 594, respectively. Then, a restriction device 563 such as a nut may be secured, or coupled, to the fastener 565 to complete the coupling of the attachment portion 564, and thus, the ground displacing element 560, to the cylindrical portion 541.

Further, in one or more embodiments, the blade portion 562 of the ground displacing elements 560 defines, or includes, a ground lifting surface 568 that may be described as being bent, or angled, so as to define a first portion 590 and a second portion 593 as shown in FIG. 1E. The first portion 590 and the second portion 593 may lie, or extend within, different planes than each other so as to be described as being non-planar, or not lying substantially in a single plane. For example, the first portion 590 may lie in a first plane and the second portion 593 may lie in a second plane, and the first plane may be different, or intersect with, the second plane defining an angle. The angle between the first portion 590 and the second portion 593 may be between about 185 degrees to about 300 degrees. For example, the angle may be greater than or equal to about 185 degrees, greater than or equal to about 200 degrees, greater than or equal to about 210 degrees, greater than or equal to about 220 degrees, greater than or equal to about 230 degrees, greater than or equal to about 240 degrees or more, greater than or equal to about 250 degrees or more, greater than or equal to about 260 degrees or more, greater than or equal to about 270 degrees or more, greater than or equal to about 280 degrees or more, etc. Further, for example, the angle may be less than or equal to about 330 degrees, less than or equal to about 310 degrees, less than or equal to about 300 degrees, less than or equal to about 285 degrees, less than or equal to about 275 degrees, less than or equal to about 265 degrees, less than or equal to about 255 degrees, less than or equal to about 245 degrees, less than or equal to about 225 degrees, or less than or equal to about 200 degrees, etc.

The first portion 590 and the second portion 593 may be described as intersecting at an apex 588. Further, the first portion 590 and the second portion 593 may be described as providing, or defining, a chisel edge 587 extending along at least a portion of the blade portion 562. In other words, the apex 588 may define the point, or edge, of the chisel edge 587 of the blade portion 562. The chisel edge 587 may be described as an edge of a blade or knife configured to cut into the ground surface. The chisel edge 587 may engage the ground surface prior to the remainder of the ground displacing element 560 when the roller apparatus 540 is engaged with the ground surface as the vehicle traverses the ground.

Further, as shown in FIG. 1F, the chisel edge 587 extend around the perimeter, or at least a portion (e.g., the majority) of the perimeter of the blade portion 562. More specifically, the chisel edge 587 may be described as being included or defined on the forward or leading edge 601 of the blade portion 562 and the rear or trailing edge 602. The forward edge 601 may be further described as being opposite the rearward edge 602 as, e.g., the forward edge 601 may face the direction of rotation while the rearward edge 602 may face opposite the direction of rotation of the cylindrical portion. The chisel edge 587 may be described as extending entirely around the blade portion 562 except for an attachment region 605 where the blade portion 562 is attached, or fixed, to the attachment portion 564. Further, the chisel edge 587 may be described as the first portion or region of the blade portion 562 to enter or contact the ground surface when being used to engage and disperse ground material. Additionally, each of the forward and rearward edges 601 and 602 may meet, or intersect, at a point, or tip, 603 of the blade portion 562. In this embodiment, the rearward edge 602 is curved or defines a curve. In other embodiments, the rearward edge 602 may not be curved, and instead, extend along a linearly line or a mixture of linear and curved. For example, a majority of the rearward edge 602 may be curved while a minority is linear. The curvature of the rearward edge 602 may assist the entering, or engaging, of the ground displacing element 560 into the ground surface. Further, the majority of the forward edge 601 extends linearly (e.g., non-curved) to the point 603. In other embodiments, the forward edge 601 may not be straight, and instead, be at least partially curved.

Further, as shown best in FIG. 1G, the blade portions 562 of the ground displacing elements 560 may be described as being tilted or rotated 611 about an axis 610 with respect to the forward moving direction of the implement 510. The axis 610 may extend from the cylindrical portion radially (e.g., perpendicularly to a tangent of the circumference of the cylindrical portion) and the blade portions 562 may be described as being rotated, or angled, 611 about the axis 610 with the forward moving direction being zero degrees. In other words, the blade portions 562 may extend out of a plane lying parallel to the forward moving or rolling direction of the implement 510. For example, a plane parallel to the moving or rolling direction of the implement 510 is represented by dashed line 512 in FIG. 1B proximate one of the ground displacing elements 560. As shown, the blade portion 562 does not substantially lie within the plane represent by dashed line 512 and is, instead, tilted or rotated with respect to the plane. The tilt, or rotation, 611 of the blade portions 562 may assist the blade portions 562 to extend through the ground surface 12 to engage the ground material (e.g., dig, lift, rip, etc. the ground material). Further, as shown, the plurality of ground displacing elements 560 may include blade portions 562 tilted, or rotated, in different (e.g., opposite) directions.

In other words, the blade portions 562 may each being described as lying, or extending, in a plane, and the plane may not be perpendicular (or parallel) to the rolling axis of the cylindrical portion 541. For example, the plane within which the blade portion lies may be considered to be twisted, or angled, from the radial axis, or line, 610, which is perpendicular to the rolling axis of the cylindrical portion 541.

The blade portions 562 of the ground displacing elements 560 may be described as being tilted or rotated 611 about the axis 610 from the forward moving direction between about 0 and about 45 degrees. In one or more embodiments, the blade portions 562 of the ground displacing elements 560 may be described as being tilted or rotated 611 about the axis 610 from the forward moving direction greater than or equal to about 2 degrees, greater than or equal to about 4 degrees, greater than or equal to about 5 degrees, greater than or equal to about 8 degrees, greater than or equal to about 10 degrees, greater than or equal to about 12 degrees, greater than or equal to about 14 degrees, greater than or equal to about 16 degrees, greater than or equal to about 20 degrees, greater than or equal to about 25 degrees, greater than or equal to about 30 degrees, greater than or equal to about 35 degrees, etc. Further, in one or more embodiments, the blade portions 562 of the ground displacing elements 560 may be described as being tilted or rotated 611 about the axis 610 from the forward moving direction less than or equal to about 45 degrees, less than or equal to about 40 degrees, less than or equal to about 38 degrees, less than or equal to about 34 degrees, less than or equal to about 32 degrees, less than or equal to about 27 degrees, less than or equal to about 23 degrees, less than or equal to about 18 degrees, less than or equal to about 13 degrees, less than or equal to about 11 degrees, less than or equal to about 9 degrees, less than or equal to about 7 degrees, less than or equal to about 3 degrees, etc.

Additionally, the ground lifting surface 568 of the blade portion 562 may be described as extending at non-radial angle. For example, substantially all or a majority of the ground lifting surface 568 may not extend along a radial line (e.g., a line that extends through the rolling axis 16 of the cylindrical portion 541). In other words, substantially all or a majority of the ground lifting surface 568 may extend along a dashed line 581 shown in FIG. 1C that does not extend through the rolling axis 16 of the cylindrical portion 541. Further, in other words, substantially all or a majority of the ground lifting surface 568 may extend along a dashed line 581 that does not form a right angle with a tangential line (i.e., a line tangential to outer cylindrical surface 543) where the dashed line 581 enters the outer cylindrical surface 543. Still further, the ground lifting surface 568 may be described as being forward slanted or angled towards the rolling direction of the cylindrical portion 541. More specifically, substantially all or a majority of the ground lifting surface 568 may extend along a dashed line 581 that forms an acute angle with a tangential line (i.e., a line tangential to outer cylindrical surface 543) where the dashed line 581 enters the outer cylindrical surface 543.

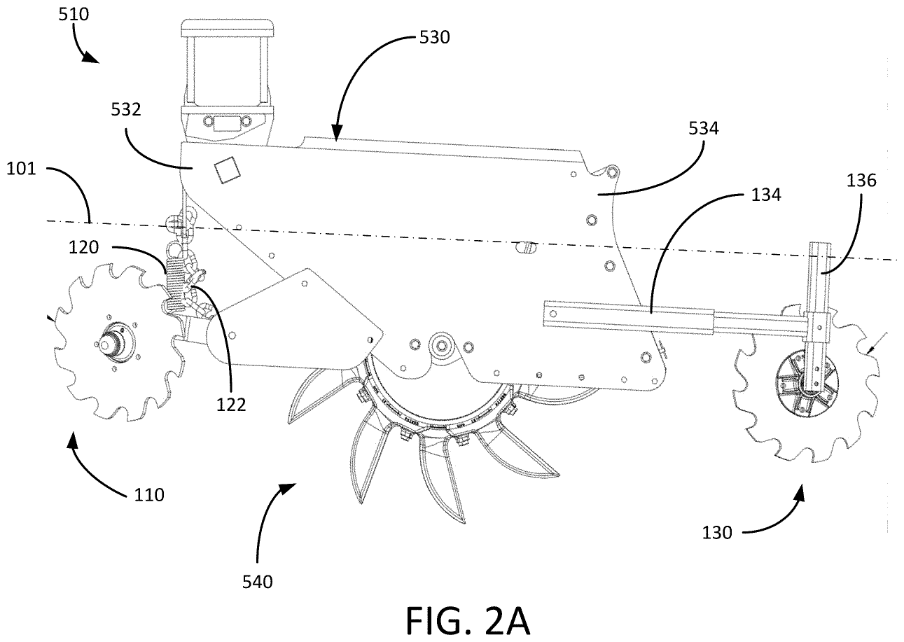

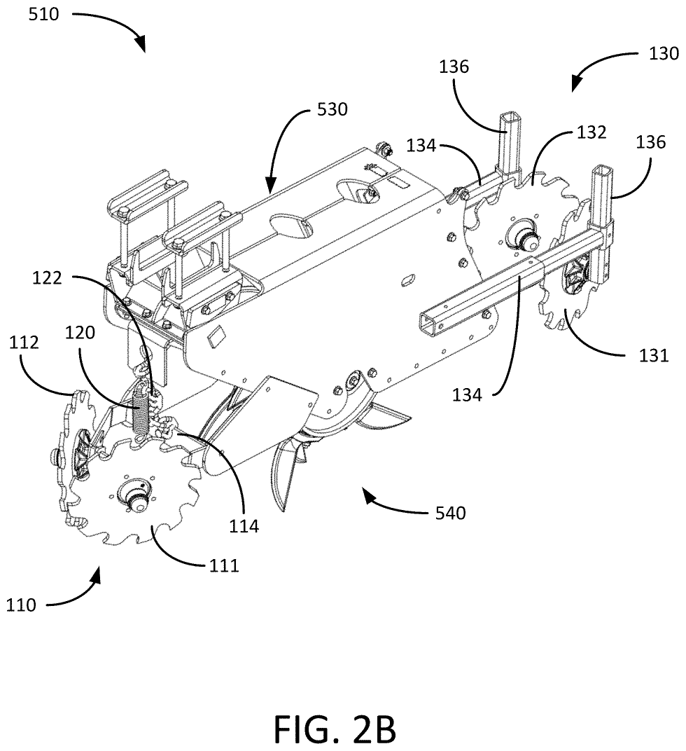

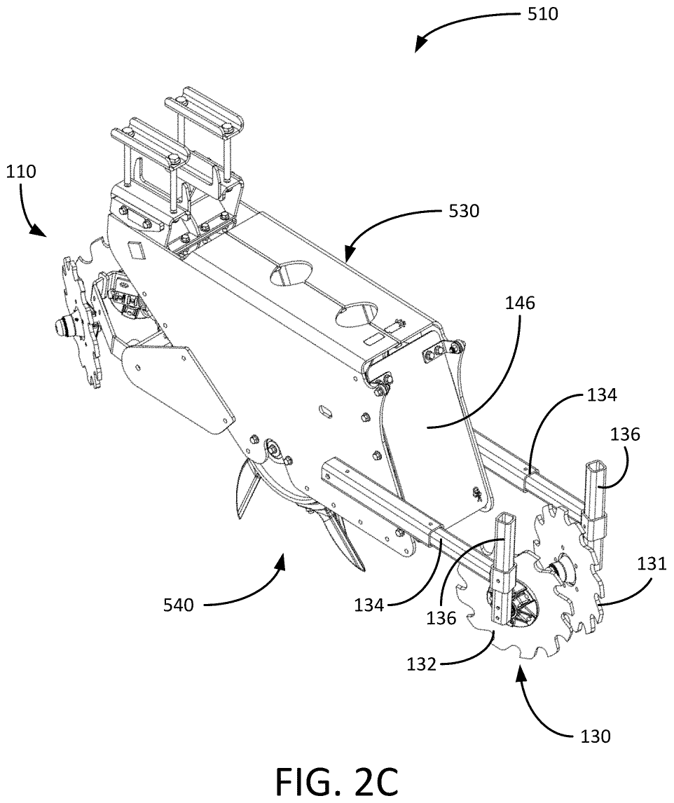

Furthermore, in one or more embodiments, the implement apparatus 510 may also include additional components to assist in tilling the rows of crops. For example, as shown in FIGS. 2A-2C, the implement apparatus 510 may include a cleaner apparatus 110 extending forward along a longitudinal axis 101 (e.g., extending between the proximal end portion 532 and the distal end portion 534 of the extension member 530) from the roller apparatus 540. Specifically, the cleaner apparatus 110 may be located proximate the proximal end portion 532 of the extension member 530. The cleaner apparatus 110 may include one or more cleaners positioned to lead the implement apparatus 510 through various debris and residue on the ground surface. The cleaners may be configured to extend at least partially under the ground surface to assist in diverting debris and residue.

The one or more cleaners may define any suitable shape and size. For example, in one or more embodiments, the cleaners may define a circular shape and may be configured to rotate relative to the ground surface (e.g., to reduce resistance with the ground surface, to assist in moving debris and residue). Specifically, the one or more cleaners may include a thin disc defining a thickness of about 0.25 inches to about 0.5 inches (e.g., specifically about 0.375 inches). In one or more embodiments, the one or more cleaners may be described as a plate or sheet and define any suitable geometry (e.g., square, triangle, rectangle, circle, etc.). Further, in one or more embodiments, the cleaners may include teeth defining a circumferential profile of the cleaner. The teeth may assist in grabbing the debris and residue and moving it towards the sides of the implement 510.

As shown in FIGS. 2A-2C, the cleaner apparatus may include a pair of cleaners 111, 112 configured to rotate relative to the ground surface. Further, the pair of cleaners 111, 112 may be oriented such that the cleaners 111, 112 angle towards one another at a forwardmost point of the pair of cleaners 111, 112. In one or more embodiments, the cleaner apparatus 110 may only include a single cleaner (e.g., taking the shape of one cleaner as shown in FIGS. 2A-2C or a single unitary piece shaped similar to the pair of cleaners)

The pair of cleaners 111, 112 may be adapted to clear the path from debris and residue from the path of the roller apparatus 540. For example, debris and residue (e.g., downed corn stalks) may have fallen between rows of crops that could clog the roller apparatus 540 if left in the path. Therefore, the cleaners 111, 112 may be angled to towards a point facing forward such that the debris and residue may deflect off the side of the cleaners 111, 112 (e.g., to avoid the roller apparatus). Specifically, the cleaners 111, 112 may be angled relative to one another at an angle of about 15 to 45 degrees.

The cleaner apparatus 110 may also include a bracket 114 (e.g., as shown in FIG. 2B) pivotably coupled to the extension member 530 and fixedly coupled to the pair of cleaners 111, 112 such that the pair of cleaners 111, 112 may pivot relative to the extension member 530. In other words, the angle and distance between the cleaners 111, 112 may be fixed based on the structure of the bracket 114. Also, the cleaners 111, 112 may pivot in unison due to being fixedly attached to the bracket 114. For example, if the cleaners 111, 112 pass over a bump or rock, the cleaners 111, 112 may pivot upward to prevent damage that may result from an inflexible pair of cleaners 111, 112. Further, in one or more embodiments, the cleaner apparatus 110 may also include a spring 120 and a chain 122 (e.g., a log chain) attached between the extension member 530 and the pair of cleaners 111, 112. The spring 120 and the chain 122 may set the drop distance (or float) of the cleaners 111, 112 relative to the ground surface and may provide some cushioning to any jarring resulting from undulations of the terrain (e.g., over which the implement 510 is traveling). Specifically, the cleaners 111, 112 may be positioned such that an edge of the disc (e.g., the teeth) is just below the ground surface and, e.g., the chain 122 may help control that elevation.

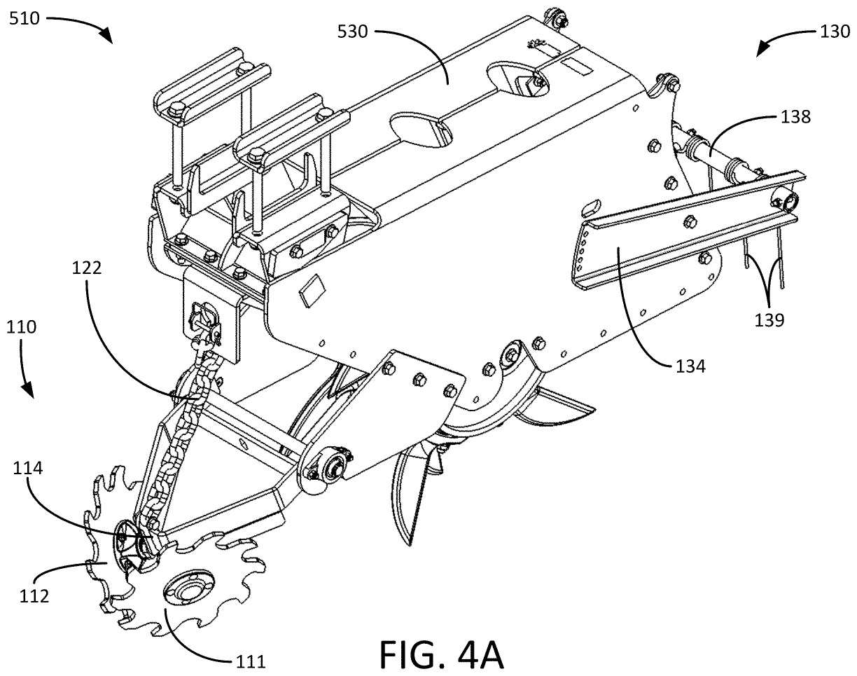

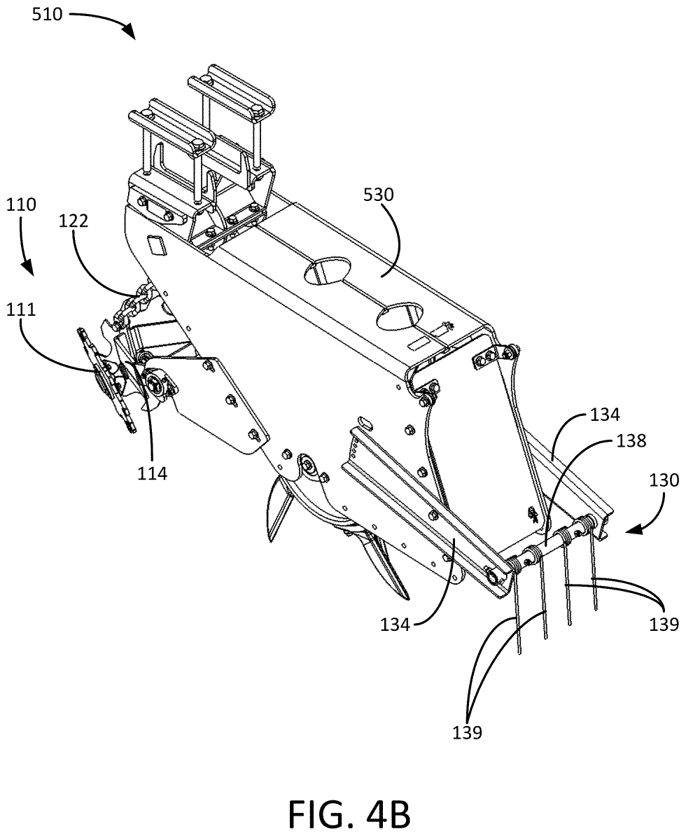

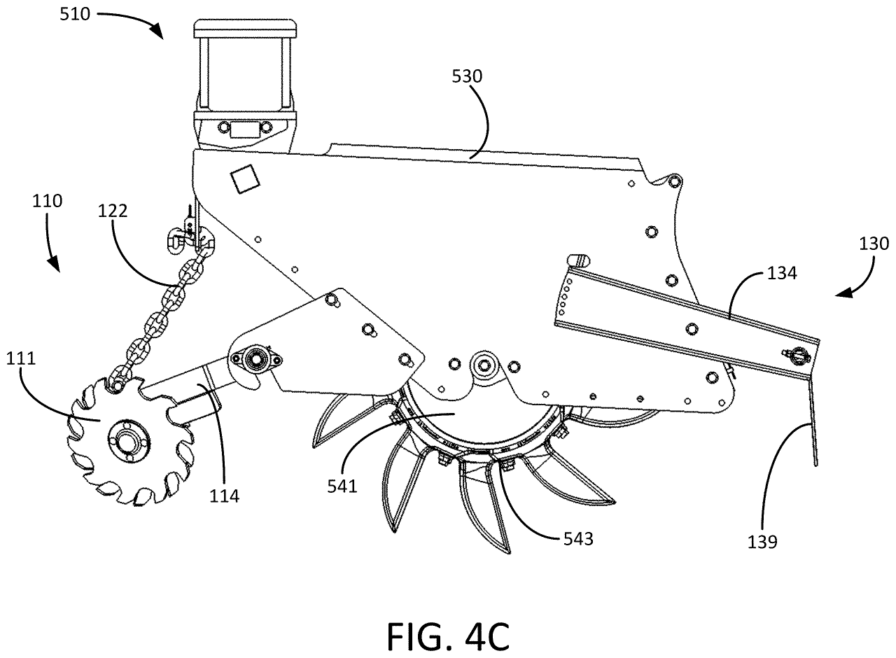

It is noted that, in one or more embodiments, the cleaner apparatus 110 may only include a chain 122 (e.g., not including a spring 120) attached between the extension member 530 and the bracket 114 (e.g., as shown in FIGS. 4A-4C). Specifically, the chain 122 (e.g., as shown in FIG. 4A) may be coupled to the extension member 530 and a front portion of the bracket 114. Therefore, the chain 122 may support each of the cleaners 111, 112 through the bracket 114.

The implement 510 may also include a hipper apparatus 130 extending rearward along the longitudinal axis 101 from the roller apparatus 540. The hipper apparatus may include a first hipper 131 and a second hipper 132. The first and second hippers 131, 132 may be oriented such that the hippers 131, 132 angle towards one another at a rearwardmost point of the first and second hippers 131, 132. Specifically, the hippers 131, 132 may be angled relative to one another at an angle of about 15 to 45 degrees. The hippers may include a thin disc defining a thickness of about 0.25 inches to about 0.5 inches (e.g., specifically about 0.375 inches). In one or more embodiments, the hippers may be described as a plate or sheet and define any suitable geometry (e.g., square, triangle, rectangle, circle, etc.). Also, each of the hippers 131, 132 may include teeth defining a circumferential profile of the hipper 131, 132. It is noted that while the hipper apparatus 130 as shown in FIGS. 2A-2C includes two hippers, any suitable number of hippers (e.g., including one) may be contemplated herein.

The hipper apparatus 130 may act as a closer to guide the soil or dirt back into the center of the path of the implement 510. For example, after the roller apparatus 540 travels over the ground surface, the dirt or soil that is loosened and kicked up may move away from the center of the path of the implement 510. Therefore, the hipper apparatus 130 may pull that soil or dirt back to the middle and form mounds that may settle over time.

The hipper apparatus 130 may include an arm 134 for each of the first and second hippers 131, 132 to extend the hippers 131, 132 backwards and away from the roller apparatus 540. The arms 134 may be coupled between the extension member 530 and the corresponding hipper 131, 132 such that each hipper 131, 132 may be adapted to pivot independently relative to the extension member 530. In one or more embodiments, the hipper apparatus 130 may also include a stopper adapted to limit the pivotal movement of the arm 134 relative to the extension member 530. For example, the hippers 131, 132 may pivot independently such that if one or both of the hippers 131, 132 encounter a rock or bump, the affected hipper may deflect upwards as needed. Further, the stopper may prevent the hippers 131, 132 from pivoting downward further than desired by the user. The stopper may be adjustable to control the angle and position of the arms 134.

Furthermore, the arms 134 for each of the first and second hippers 131, 132 may have an adjustable length along the longitudinal axis 101. In other words, the distance that the hippers 131, 132 extend rearward from the extension member 530 may be adjustable as desired. For example, in one or more embodiments, the first and second hippers 131, 132 may be positioned at the same distance from the extension member 530 along the longitudinal axis 101. In other embodiments, the first and second hippers 131, 132 may be positioned to be staggered relative to the extension member 530 along the longitudinal axis 101 (e.g., the first and second hippers 131, 132 may be positioned at different distances from the extension member 530). Therefore, if the gap between the hippers 131, 132 is too small to allow some debris to pass through the gap, the length of the hippers 131, 132 may be adjusted such that the hippers 131, 132 are offset along the longitudinal axis 101. Further, in one or more embodiments, the arms 134 may be completely detachable (e.g., if designed to have two telescoping portions for adjustability) such that the implement 510 may be operated without the presence of the hipper apparatus 130 or having only a single hipper.

In one or more embodiments, the hipper apparatus 130 may include a vertical support 136 coupled between each of the first and second hippers 131, 132 and the corresponding arm 134. The vertical support 136 may be movably coupled to the arm 134 such that the first and second hippers 131, 132 may be adapted to be vertically adjusted relative to the extension member 530. For example, the hippers 131, 132 may be adjust based on the height of the roller apparatus 540 and the distance between the ground surface and the hippers 131, 132.

In another embodiment of the implement apparatus 510, the hipper apparatus 130 may include one or more finger elements 139 or teeth that extend downward, e.g., as shown in FIGS. 4A-4C. For example, the one or more finger elements 139 may extend into the ground surface during operation to help disperse and level the ground after the tilling and displacing via the ground displacement element 560. For example, in one or more embodiments, the hipper apparatus 130 may include arms 134 coupled to and extending from the extension member 530 to a position rearward of the extension member 530. Also, a crossmember 138 may extend between the arms 134 and the one or more finger elements 139 may be operatively coupled to the crossmember 138. Therefore, the one or more finger elements 139 may be span a width of the implement apparatus 510 and disperse the ground along that width.

The one or more finger elements 139 may include any suitable number of finger elements 139 and may be spaced apart in any suitable way. For example, as shown in FIG. 4B, the hipper apparatus 130 may include four finger elements evenly spaced apart along the crossmember 138. Additionally, the one or more finger elements 139 may define any suitable length. For example, the one or more finger elements 139 may define a length such that a distal end of the finger elements extend into the ground surface when the implement apparatus 510 is in use (e.g., such that the distal end is below the outer cylindrical surface 543 of the cylindrical portion 541). In one or more embodiments, the arm 134 may be adjusted (e.g., vertically or pivotally) to set the position of the finger elements 139 (e.g., to ensure the distal end is in the ground surface).

The one or more finger elements 139 may include (e.g., be formed of) any suitable material. For example, the one or more finger elements 139 may include a wire that may or may not deform, but maintains shape. Further, the one or more finger elements 139 may be coupled to the crossmember 138 in any suitable way. For example, as shown in FIG. 4B, the one or more finger elements 139 may wrap around the crossmember 138 to couple thereto. As such, the one or more finger elements 139 may pivot relative to the crossmember 138 or deflect as the one or more finger elements traverses the ground surface. In other words, the one or more finger elements 139 may define a robustness to engage and disperse portions of the ground surface, but flexible enough to deflect over undulations or rocks.

As such, different combinations of the cleaner apparatus 110, the roller apparatus 540, and the hipper apparatus 130 may be used for various different applications. For example, in the Fall, the implement apparatus 510 may be set up to include all three of the cleaner apparatus 110, the roller apparatus 540, and the hipper apparatus 130 for strip tilling between crop rows (e.g., to set things up for the Spring). Then, in the Spring, the implement 510 may include the cleaner apparatus 110 and the roller apparatus 540 to aerate and freshen the soil (or, e.g., deposit fertilizer). After the crop is up, the implement 510 may be used once again to aerate the ground surface and form reservoirs in the ground surface to collect water. Additionally, in an implement configuration that only includes the cleaner apparatus 110 and the roller apparatus 540, the cleaner apparatus 110 may push fertilizer or nitrogen into the crops (e.g., because the hipper apparatus 130 is not present to pull the fertilizer back towards the center).

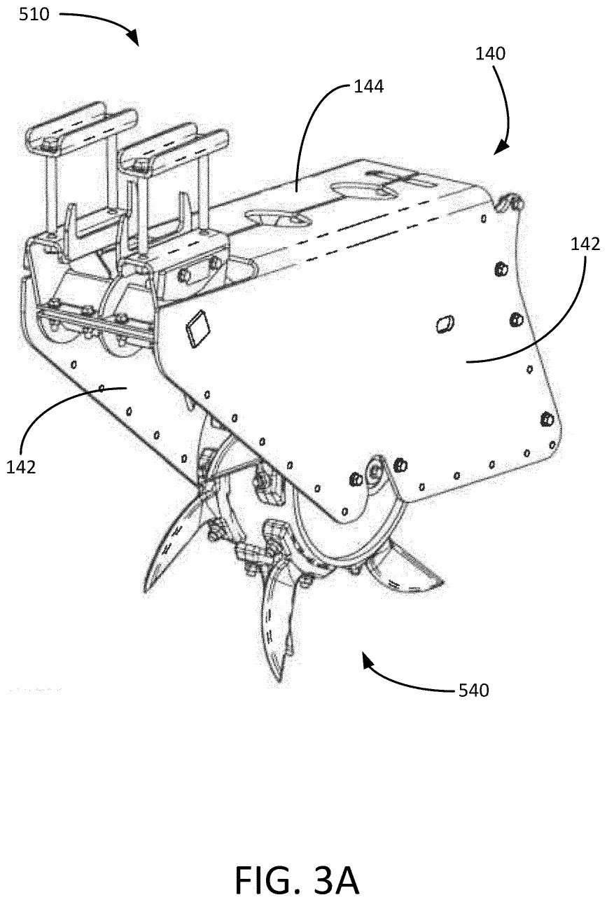

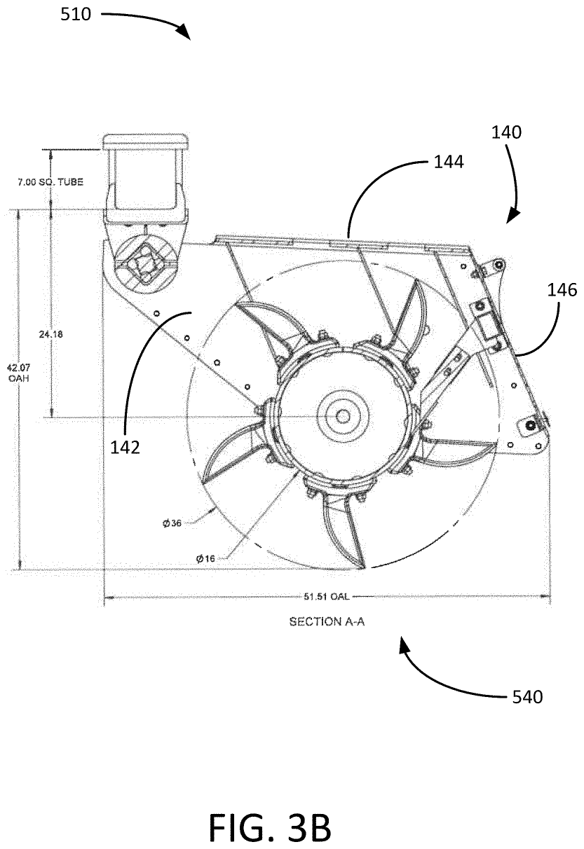

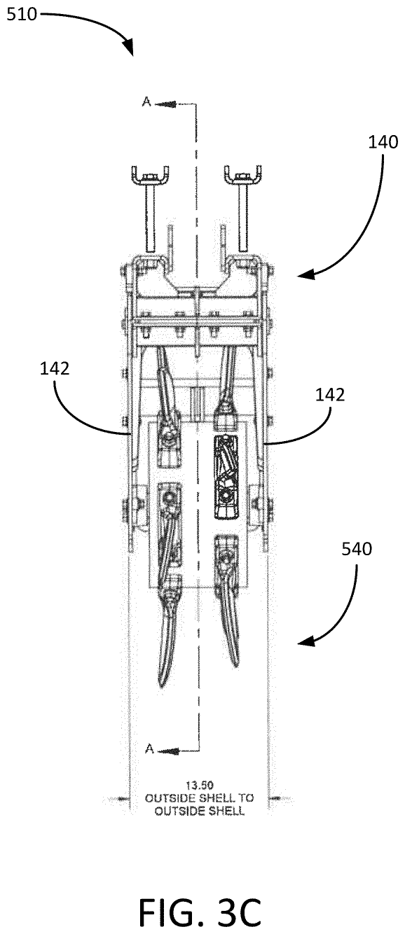

Additionally, as shown in FIGS. 3A-3C, the implement 510 may also include a housing 140 at least partially surrounding the roller apparatus 540. The housing 140 may include side plates 142 positioned on either side of the roller apparatus 540, a top plate 144 positioned above the roller apparatus 540, and a rear plate 146 (also shown in FIG. 2C) positioned rearward of the roller apparatus 540. The housing 140 may assist in containing dirt or soil that might otherwise be thrown to the side by the roller apparatus 540. For example, dirt or soil that is kicked-up by the roller apparatus 540 may enter the housing 140 and land generally within the path of the implement 510. Also, in one or more embodiments, the rear plate 146 may be pivotally coupled to the top plate 144 and/or the side plates 142 such that the rear plate 146 may pivot at the top end for servicing the roller apparatus 540 or cleaning out debris that may get caught in the housing 140.

In any of the embodiments discussed herein, one or more ground breaking apparatus (e.g., sweep blades, row crop sweeps, chisel elements, or sweep cultivators) may be coupled to any of the implements or systems described herein. The one or more ground breaking apparatus may be configured to break up or loosen the ground material prior to the roller apparatus forming reservoirs in the ground surface (e.g., mounted ahead of the roller apparatus in the direction of travel).

All patents, patent documents, and references cited herein are incorporated in their entirety as if each were incorporated separately. This disclosure has been provided with reference to illustrative embodiments and is not meant to be construed in a limiting sense. As described previously, one skilled in the art will recognize that other various illustrative applications may use the techniques as described herein to take advantage of the beneficial characteristics of the exemplary apparatus described herein. Various modifications of the illustrative embodiments, as well as additional embodiments of the disclosure, will be apparent upon reference to this description.

What is claimed:

1. An implement apparatus couplable to a vehicle configured to traverse a ground surface, wherein the implement apparatus comprises:
an extension member couplable to the vehicle and extending between a proximal end portion and a distal end portion along a longitudinal axis;
a roller apparatus rotatably coupled proximate the distal end portion of the extension member and configured to engage the ground surface when the vehicle traverses the ground surface, wherein the roller apparatus comprises:
a cylindrical portion defining an outer cylindrical surface and lying along a roller axis configured to rotate as the vehicle traverses the ground surface; and
a plurality of ground displacing elements coupled to the cylindrical portion and extending from the outer cylindrical surface of the cylindrical portion, wherein each ground displacing element of the plurality of ground displacing elements defines a chisel edge and is configured to extend into the ground surface to displace ground material when the roller apparatus is engaged with the ground surface as the vehicle traverses the ground surface; and
a cleaner apparatus extending forward along the longitudinal axis from the roller apparatus and located proximate the proximal end portion of the extension member, wherein the cleaner apparatus comprises a pair of cleaners oriented such that the cleaners angle towards one another at a forwardmost point of the pair of cleaners.

2. The implement apparatus of claim 1, wherein each cleaner of the pair of cleaners is configured to rotate relative to the ground surface.

3. The implement apparatus of claim 1, further comprising a housing at least partially surrounding the roller apparatus, wherein the housing comprises side plates positioned on either side of the roller apparatus, and a top plate positioned above the roller apparatus and extending between the side plates.

4. The implement apparatus of claim 3, wherein the housing further comprises a rear plate positioned rearward of the roller apparatus.

5. The implement apparatus of claim 1, wherein each of the pair of cleaners comprises teeth defining a circumferential profile of the cleaner.

6. The implement apparatus of claim 1, wherein the pair of cleaners are angled relative to one another at an angle of about 15 to 45 degrees.

7. The implement apparatus of claim 1, wherein the cleaner apparatus further comprises a bracket pivotably coupled to the extension member and fixedly coupled to the pair of cleaners such that the pair of cleaners pivot relative to the extension member.

8. The implement apparatus of claim 1, wherein the cleaner apparatus further comprises a chain attached between the extension member and the pair of cleaners.

9. The implement apparatus of claim 1, wherein the outer cylindrical surface is configured to engage the ground surface when the cylindrical portion is rolled over the ground surface.

10. The implement apparatus of claim 1, wherein the plurality of ground displacing elements are arranged in at least one row circumferentially extending around the outer cylindrical surface of the cylindrical portion.

11. The implement apparatus of claim 1, wherein at least one ground displacing element of the plurality of ground displacing elements comprises:
a first portion extending along a first plane, and
a second portion extending along a second plane, wherein the first plane and the second plane intersect at an apex defining the chisel edge.

12. The implement apparatus of claim 1, wherein at least one ground displacing element of the plurality of ground displacing elements defines a forward edge and a rearward edge opposite the forward edge, wherein each of the forward edge and the rearward edge define the chisel edge.

13. The implement apparatus of claim 1, wherein at least one ground displacing element of the plurality of ground displacing elements defines a forward edge and a rearward edge opposite the forward edge, wherein the rearward edge is curved.

14. The implement apparatus of claim 1, wherein the plurality of ground displacing elements comprises four or more ground displacing elements.

15. The implement apparatus of claim 1, wherein a radius of the cylindrical portion perpendicular to the roller axis extends from the roller axis to the outer cylindrical surface, wherein at least one ground displacing element of the plurality of ground displacing elements extends from the outer cylindrical surface to a distal edge defining an element length, wherein the element length is greater than the radius of the cylindrical portion.

16. The implement apparatus of claim 1, further comprising a hipper apparatus extending rearward along the longitudinal axis from the roller apparatus, wherein the hipper apparatus comprises one or more finger elements extending downward toward the ground surface.

17. The implement apparatus of claim 1, further comprising a hipper apparatus extending rearward along the longitudinal axis from the roller apparatus, wherein the hipper apparatus comprises a first hipper and a second hipper, wherein the first and second hippers are oriented such that the hippers angle towards one another at a rearwardmost point of the first and second hippers.

18. The implement apparatus of claim 17, wherein the hipper apparatus comprises an arm for each of the first and second hippers, wherein the arms are coupled between the extension member and the corresponding hipper such that each hipper is adapted to pivot independently relative to the extension member.

19. The implement apparatus of claim 18, wherein the arms for each of the first and second hippers have adjustable length along the longitudinal axis.

20. The implement apparatus of claim 17, wherein the first and second hippers are angled relative to one another at an angle of about 15 to 45 degrees.
